(19) United States
(12) Patent Application Publication
(10) Pub. No.: US 2013/0120227 A1
(43) Pub. Date: May 16, 2013

(54) DISPLAY AND ELECTRONIC UNIT

(71) Applicant: Sony Corporation, Tokyo (JP)

(72) Inventor: Toru Tanikawa, Kanagawa (JP)

(73) Assignee: SONY CORPORATION, Tokyo (JP)

(21) Appl. No.: 13/672,372

(22) Filed: Nov. 8, 2012

(30) Foreign Application Priority Data
Nov. 16, 2011 (JP) 2011-250716

(51) Int. Cl. G09G 3/00

(52) U.S. Cl. CPC G09G 3/00
USPC 345/55

(57) ABSTRACT

A display includes: a drive substrate having a display region and a bonding region around the display region; a display layer provided on the display region; a surface film disposed to face a display surface of the display layer; and a moisture proof film interposed between the display layer and the surface film while being in contact with the drive substrate in the bonding region, and sealing the display layer between the moisture proof film and the drive substrate.

### CROSS REFERENCES TO RELATED APPLICATIONS

The present application claims priority to Japanese Priority Patent Application JP 2011-250716 filed in the Japan Patent Office on Nov. 16, 2011, the entire content of which is hereby incorporated by reference.

### BACKGROUND

The present application relates to a display having a moisture proof film for a display layer, and an electronic unit including the display.

Liquid crystal displays are currently widely used as flat displays such as a television, and attention is now focused on a display that allows a further reduction in size and power consumption.

In such a display, a display layer tends to be degraded by water. Hence, several techniques have been proposed to prevent infiltration of water into the display layer (for example, see Japanese Unexamined Patent Application Publication No. 2005-114820 and Japanese Unexamined Patent Application Publication (Translation of PCT Application) No. 2009-529711). Japanese Unexamined Patent Application Publication (Translation of PCT Application) No. 2009-529711 discloses a display having a configuration where a display layer is sealed on a substrate by a film disposed at an uppermost surface (a film most away from the substrate in a laminating direction) to improve the moisture proof property of the display.

### SUMMARY

The film disposed at the uppermost surface, however, has a large thickness to protect the display layer and other layers from external force. It is therefore difficult to fold the film at an acute angle along a side face of a laminated structure including the display layer and the like. Specifically, when the film is made to be in contact with the substrate, the film necessarily has a gentle shape from a display region through any region (frame region) other than the display region, thereby resulting in large area of the frame region.

It is desirable to provide a display that has a high moisture proof property, and allows a reduction in frame size, and an electronic unit including the display.

According to an embodiment of the present application, there is provided a display including: a drive substrate having a display region and a bonding region around the display region; a display layer provided on the display region; a surface film disposed to face a display surface of the display layer; and a moisture proof film interposed between the display layer and the surface film while being in contact with the drive substrate in the bonding region, and sealing the display layer between the moisture proof film and the drive substrate.

According to an embodiment of the application, there is provided an electronic unit including a display. The display includes: a drive substrate having a display region and a bonding region around the display region; a display layer provided on the display region; a surface film disposed to face a display surface of the display layer; and a moisture proof film interposed between the display layer and the surface film while being in contact with the drive substrate in the bonding region, and sealing the display layer between the moisture proof film and the drive substrate.

In the display and the electronic unit according to the embodiments of the application, the moisture proof film sealing the display layer and the surface film at the uppermost surface are separately provided on the display layer, thereby allowing the moisture proof film to be reduced in thickness so as to be readily deformable. This enables the moisture proof film to be deformed along a shape of the display layer. As a result, the moisture proof film is bonded to the drive substrate in a region close to the display region, thereby leading to a short interval between the bonding region and the display region.

According to the display and the electronic unit of the embodiments of the application, the moisture proof film sealing the display layer is separated from the film disposed at the uppermost surface. This makes it possible to improve the moisture proof property, and reduce a distance between the display region and the bonding region, leading to small frame size.

Additional features and advantages are described herein, and will be apparent from the following Detailed Description and the figures.

### BRIEF DESCRIPTION OF THE FIGURES

The accompanying drawings are included to provide a further understanding of the disclosure, and are incorporated in and constitute a part of this specification. The drawings illustrate embodiments and, together with the specification, serve to explain the principles of the application.

FIG. 1 is a sectional view illustrating a configuration of a display according to an embodiment of the present disclosure.

FIG. 2 is a plan view illustrating a configuration of a drive substrate illustrated in FIG. 1.

FIGS. 3A and 3B are sectional views illustrating steps of a method of manufacturing the display illustrated in FIG. 1.

FIGS. 4A and 4B are sectional views illustrating steps following the step of FIG. 3B.

FIG. 5 is a sectional view illustrating a configuration of a display according to a comparative example 1.

FIG. 6 is a sectional view illustrating a configuration of a display according to a comparative example 2.

FIG. 7 is a sectional view illustrating a configuration of a display according to Modification 1.

FIG. 8 is a sectional view illustrating a configuration of a display according to Modification 2.

FIGS. 9A and 9B are sectional views illustrating steps of a method of manufacturing the display illustrated in FIG. 8.

FIGS. 10A and 10B are sectional views illustrating steps following the step of FIG. 9B.

FIG. 11 is a graph illustrating a relationship between wavelengths and transmittance of a film having an ultraviolet screening function.

FIG. 12 is a sectional view illustrating a configuration of a display according to Modification 3.

FIGS. 13A and 13B are sectional views illustrating steps of a method of manufacturing the display illustrated in FIG. 12.

FIGS. 14A and 14B are sectional views illustrating steps following the step of FIG. 13B.

FIGS. 15A and 15B are perspective views illustrating an appearance of an application example 1.

FIG. 16 is a perspective view illustrating an appearance of an application example 2.

FIG. 17A is a perspective view illustrating an appearance of an application example 3 as viewed from its front side, and FIG. 17B is a perspective view illustrating the appearance thereof as viewed from its back side.

FIG. 18 is a perspective view illustrating an appearance of an application example 4.

FIG. 19 is a perspective view illustrating an appearance of an application example 5.

FIGS. 20A and 20B are a front view and a side view of an application example 6 in an open state, respectively, and FIGS. 20C to 20G are a front view, a left side view, a right side view, a top view, and a bottom view of the application example 6 in a closed state, respectively.

### DETAILED DESCRIPTION

Hereinafter, an embodiment of the present application will be described in detail with reference to the accompanying drawings. It is to be noted that description is made in the following order.

1. Embodiment

Display having a display layer having side faces covered with a moisture proof film.

2. Modification 1

Display having a water screening section in contact with side faces of a display layer.

3. Modification 2

Display having a drive substrate having a circuit substrate thereon.

4. Modification 3

Display having a drive substrate on which a driver IC is directly mounted.

5. Application examples

### Embodiment

[Configuration of Display 1]

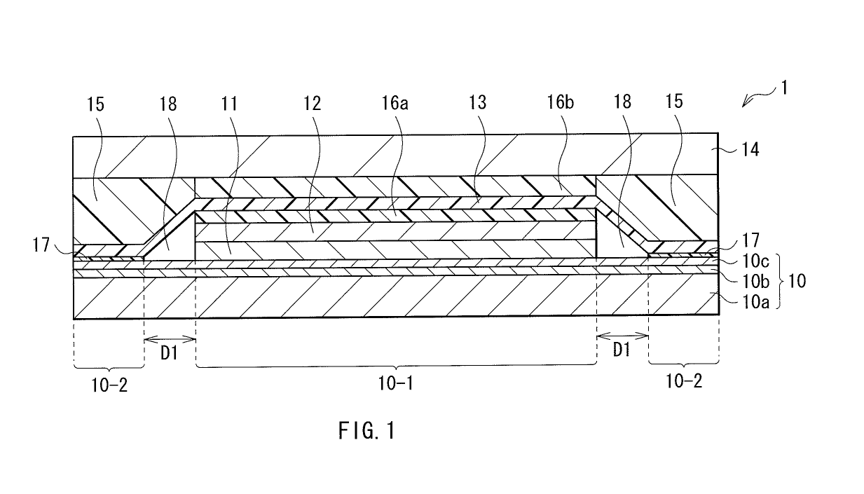

FIG. 1 illustrates a sectional configuration of a display (display 1) according to an embodiment of the present disclosure. The display 1 includes a drive substrate 10, and a display layer 11, a counter substrate 12, a moisture proof film 13, and an optical functional film 14 in this order on the drive substrate 10. It is to be noted that since FIG. 1 schematically illustrates the display 1, actual dimensions and an actual shape of the display are different from those shown in the drawing.

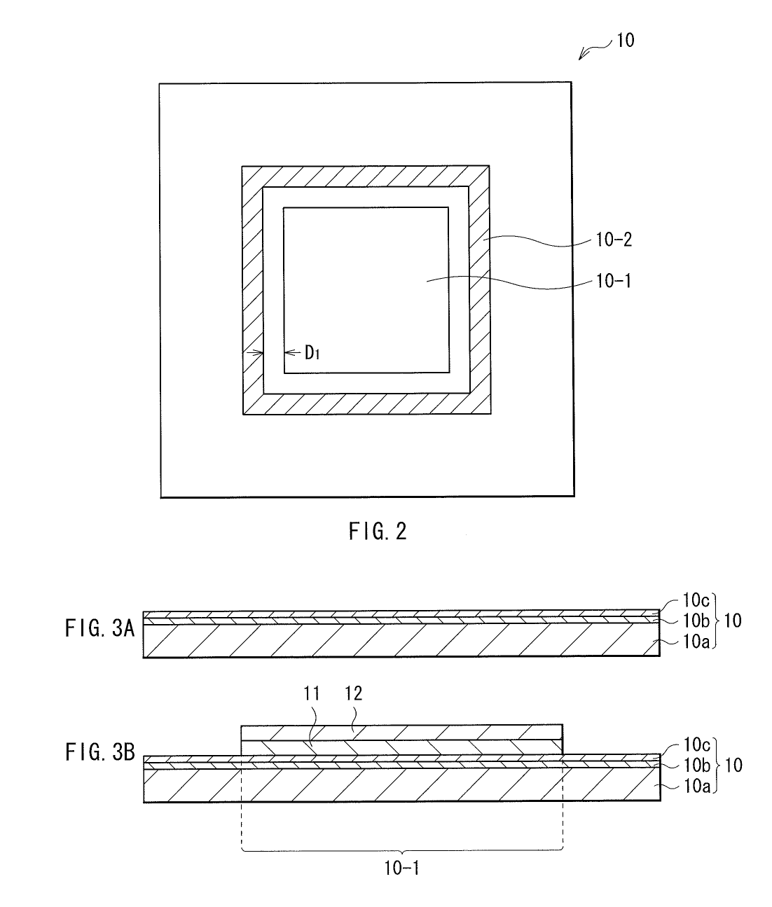

As illustrated in FIG. 2, the drive substrate 10 has a bonding region 10-2 around a central region (display region 10-1) such that the bonding region 10-2 entirely surrounds the display region 10-1. The display layer 11 is provided on the display region 10-1. An end portion of the moisture proof film 13 is bonded onto the bonding region 10-2. A distance between the display region 10-1 and the bonding region 10-2 is represented as D₁.

The drive substrate 10 includes a substrate 10a, and includes a barrier layer 10b and a thin film transistor (TFT) circuit 10c laminated in this order on the substrate 10a. Examples of the material of the substrate 10a include: inorganic materials such as glass, quartz, silicon, and gallium arsenide; metal materials such as stainless steel; and plastic materials such as polyimide, polyethylene terephthalate (PET), polyethylene naphthalate (PEN), polymethylmethacrylate (PMMA), polycarbonate (PC), polyether sulfone (PES), polyetheretherketone (PEEK), and aromatic polyesters (liquid crystal polymers). The substrate 10a may be configured of a stiff material such as a wafer, or of a flexible material such as thin-layer glass, a film, and a metal foil. A flexible substrate 10a enables a foldable display. The thickness (thickness in a laminating direction, hereinafter simply referred to as a thickness) of the substrate 10a is, for example, 10 μm to 100 μm.

The barrier layer 10b includes one of an AlO_{X}N_{1-X} (where X is 0.01 to 0.2) film and a silicon nitride (Si₃N₄) film formed by a chemical vapor deposition (CVD) process, for example. The barrier layer 10b prevents the TFT circuit 10c and the display layer 11 from being degraded by water and/or an organic gas. The barrier layer 10b is mostly deposited by the CVD process. Such a CVD-deposited barrier layer is closely packed and low in moisture permeability compared with a barrier layer deposited by an evaporation process. In this embodiment, the display layer 11 is sealed between such a barrier layer 10b and the moisture proof film 13, thereby making it possible to effectively prevent infiltration of water from the outside.

The TFT circuit 10c has a switching function to select pixels. The TFT circuit 10c may be configured of either an inorganic TFT including an inorganic semiconductor layer as a channel layer, or an organic TFT including an organic semiconductor layer as a channel layer.

The display layer 11 includes a display element such as a liquid crystal layer, an organic electroluminescence (EL) layer, an inorganic EL layer, and an electrophoresis display element, for example, between pixel electrodes and a common electrode. The pixel electrodes are in contact with the TFT circuit 10c. The common electrode is in contact with the counter substrate 12. The thickness in a laminating direction of the display layer 11 is about 40 μm to 165 μm, for example. The pixel electrodes are provided for each of pixels, and are composed of, for example, a single metal element such as chromium (Cr), gold (Au), platinum (Pt), nickel (Ni), copper (Cu), tungsten (W), aluminum (Al), and silver (Ag), or an alloy thereof. The common electrode is provided over one surface of the counter substrate 12, and is composed of a translucent conductive material (transparent electrode material) such as indium oxide/tin oxide (ITO), antimony oxide/tin oxide (ATO), fluorine-doped tin oxide (FTO), and aluminum-doped zinc oxide (AZO).

The counter substrate 12 is provided on the display region 10-1 as in the display layer 11, and has a thickness of about 125 μm, for example. Since images are displayed through the counter substrate 12 in the embodiment, a light-transmissive material is used for the counter substrate 12. However, except for that point, any material similar to the material for the substrate 10a may be used for the counter substrate 12.

The moisture proof film 13 is fixed to the counter substrate 12 with a transparent adhesive agent 16a. The transparent adhesive agent 16a is provided as an optical clear adhesive (OCA) layer having a thickness of 25 μm, for example. If the substrate 10a is configured of a flexible substrate, it is preferable that the transparent adhesive agent 16a be also flexible. The same holds true for a transparent adhesive agent 16b and an adhesive agent 17 described later.

The moisture proof film 13 is interposed between the display layer 11 and the optical functional film 14 to prevent infiltration of water into the display layer 11. The moisture proof film 13 has an area larger than that of the display region 10-1, and covers the top and the side faces of the display layer 11. The moisture proof film 13 is fixed to the drive substrate 10, which covers the bottom of the display layer 11, in the bonding region 10-2 with the adhesive agent 17. In other words, the moisture proof film 13 seals the display layer 11 on the drive substrate 10. This makes it possible to prevent infiltration of water into the display layer 11 from the outside of the display 1, in particular, infiltration of water through the side faces of the display 1, leading to an improvement in the moisture proof property of the display 1.

The moisture proof film 13 is composed of polyethylene terephthalate, polymethyl methacrylate, polycarbonate, polyethylene naphthalate, polypropylene, nylon-6, nylon-66, polyvinylidene chloride, or polyether sulfone, for example. The moisture proof film 13 may be a film of the above-described resin, on which an AlO_{X} film or a silicon nitride film is formed by the evaporation or CVD process, or may have a laminated structure configured of a plurality of resin films. The moisture proof film 13 has moisture permeability of, for example, 0.01 g/m²/day to 0.1 g/m²/day, preferably 0.05 g/m²/day or less, and preferably has a high light transmittance. The thickness of the moisture proof film 13 is, for example, 50 μm or less. In particular, 10 μm to 40 μm is preferable.

In the embodiment, the moisture proof film 13 is separated from the optical functional film 14 at the uppermost surface. This makes it possible to reduce the thickness of the moisture proof film 13, which is to be provided along the display layer 11, allowing the moisture proof film 13 to be flexible. This allows the moisture proof film 13 to be bonded to the drive substrate 10 in a region close to the display region 10-1. In other words, this makes it possible to reduce an interval between the display region 10-1 and the bonding region 10-2, i.e., reduce a distance D₁ (FIG. 1). The distance D₁ is, for example, 10 μm to 500 μm.

The moisture permeability of the adhesive agent 17 is preferably 50 g/m²/day or less in order to improve the moisture proof effect. The thickness of the adhesive agent 17 is, for example, 1 μm to 30 μm, and the width thereof, i.e., the width of the bonding region 10-2, is 0.5 mm or less. If the adhesive agent 17 has a high visible-light transmittance, the transparent adhesive agent 16a may be composed of a material similar to that of the adhesive agent 17.

The optical functional film 14 (surface film) has, for example, an anti-reflection function or antiglare function, and is disposed to face the display surface (top) of the display layer 11 with the moisture proof film 13 therebetween. The optical functional film 14 may have either a single-layer structure or a multilayer structure, and has substantially the same size as that of the drive substrate 10. For example, if the optical functional film 14 has the anti-reflection function, the optical functional film 14 is configured of a laminate configured of a plurality of thin films having different refractive indexes, and attenuates reflected light through the effect of interference of light reflected at interfaces between the thin films. In addition, for example, if the optical functional film 14 has the antiglare function, the optical functional film 14 has an irregular surface caused by a coating, and irregularly reflects outside light by the irregular surface. It is to be noted that a film, such as a hard coating, that protects the display surface from a physical stimulus (external force), a film having an ultraviolet screening function, or a film that prevents a fingerprint from being left or facilitates wiping of a fingerprint may be provided as a surface film in place of the optical functional film 14. In addition, the surface film may be a laminate configured of a plurality of films having different functions. The thickness of the optical functional film 14 is, for example, 80 μm. The transparent adhesive agent 16b for bonding of the optical functional film 14 to the moisture proof film 13 has a thickness of, for example, 25 μm, and is composed of a material similar to that of the transparent adhesive agent 16a.

The planarization layer 15 is provided to planarize the surface of the optical functional film 14 across the entire area on the drive substrate 10, and is disposed between the moisture proof film 13 and the optical functional film 14 in a region outside the display region 10-1. In other words, the planarization layer 15 is provided in a gap portion, which is formed as a result of bonding of the moisture proof film 13 to the drive substrate 10, between the moisture proof film 13 and the optical functional film 14. The planarization layer 15 may include any resin selected from various resins such as photo-curing resins, thermosetting resins, and room temperature setting resins. The planarization layer 15 preferably has low moisture permeability in order to improve the moisture proof property of the display 1. For example, the moisture permeability of the planarization layer 15 is preferably 50 g/m²/day or less at 40° C. Specifically, for example, epoxy resin may be used for the planarization layer 15. If the substrate 10a is configured of a flexible substrate, it is preferable that the planarization layer 15 be also flexible.

A portion between the display region 10-1 and the bonding region 10-2, i.e., a portion between the side faces of the display layer 11 and of the counter substrate 12 and the moisture proof film 13, sealed by the moisture proof film 13 is formed as a space 18 that thus surrounds the side faces of the display layer 11 and of the counter substrate 12.

[Method of Manufacturing Display 1]

The display 1 is manufactured in the following way, for example.

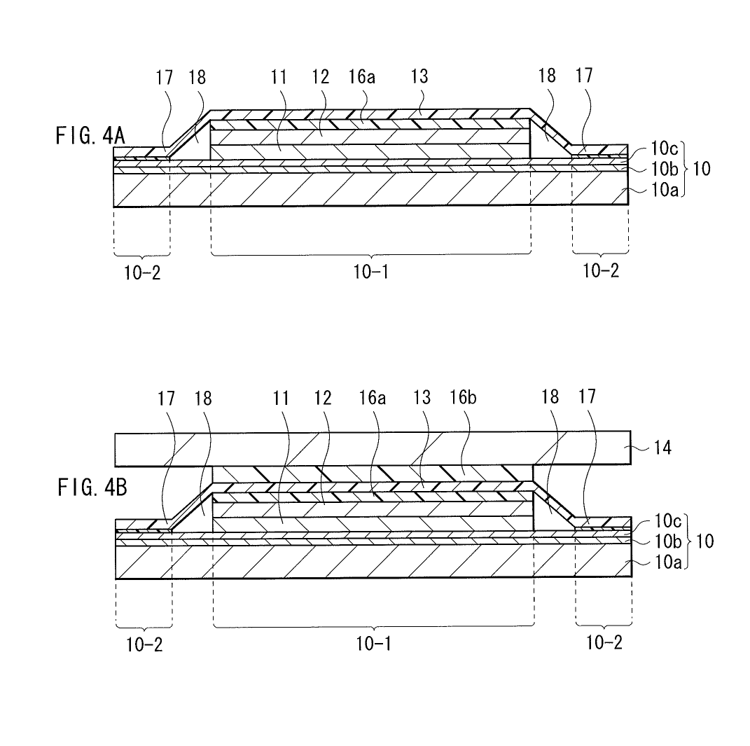

FIGS. 3A and 3B and FIGS. 4A and 4B illustrate manufacturing steps of the display 1 in sequence. First, as illustrated in FIG. 3A, the barrier layer 10b including silicon nitride is formed on the substrate 10a by, for example, a CVD process, and then the TFT circuit 10c is formed, resulting in formation of the drive substrate 10.

After formation of the drive substrate 10, a metal film including, for example, chromium, gold, platinum, nickel, copper, tungsten, aluminum, or silver is formed over the entire surface of the drive substrate 10. The metal film is then patterned into the pixel electrodes. Then, as illustrated in FIG. 3B, the display layer 11 is formed on the drive substrate 10 and the counter substrate 12 is provided thereon.

After bonding of the counter substrate 12, the moisture proof film 13 is fixed onto the counter substrate 12 with the transparent adhesive agent 16a. Here, any of the sides of the moisture proof film 13 is larger than the corresponding side of the display region 10-1, and the area of the moisture proof film 13 is larger than that of the display region 10-1. As a result, the moisture proof film 13 has a portion hanging over from the display region 10-1. Then, as illustrated in FIG. 4A, the portion, hanging over from the display region 10-1, of the moisture proof film 13 is folded toward the drive substrate 10 and fixed to the bonding region 10-2 of the drive substrate 10 with the adhesive agent 17 such that the portion covers the sides of the display layer 11.

After bonding of the moisture proof film 13 to the drive substrate 10, as illustrated in FIG. 4B, the optical functional film 14 is bonded to the moisture proof film 13 with the transparent adhesive agent 16b. If the optical functional film 14 is a laminate configured of a plurality of films, the optical functional film 14 having a laminated structure may be formed before being bonded to the moisture proof film 13. Alternatively, the plurality of films may be sequentially bonded to the moisture proof film 13 so that the optical functional film 14 is formed. Then, the space between the moisture proof film 13 and the optical functional film 14, which is formed in the region outside the display region 10-1, is filled with, for example, a photo-curing resin that is then irradiated with light to form the planarization layer 15. This is the end of manufacturing of the display 1 illustrated in FIG. 1.

[Functions and Effects of Display 1]

In the display 1 of the embodiment, the moisture proof film 13 covering the display layer 11 and the optical functional film 14 at the uppermost surface are separately provided on the display layer 11, thereby allowing the display 1 to have a high moisture proof property and small frame size. This is now described in detail as contrasted with comparative examples.

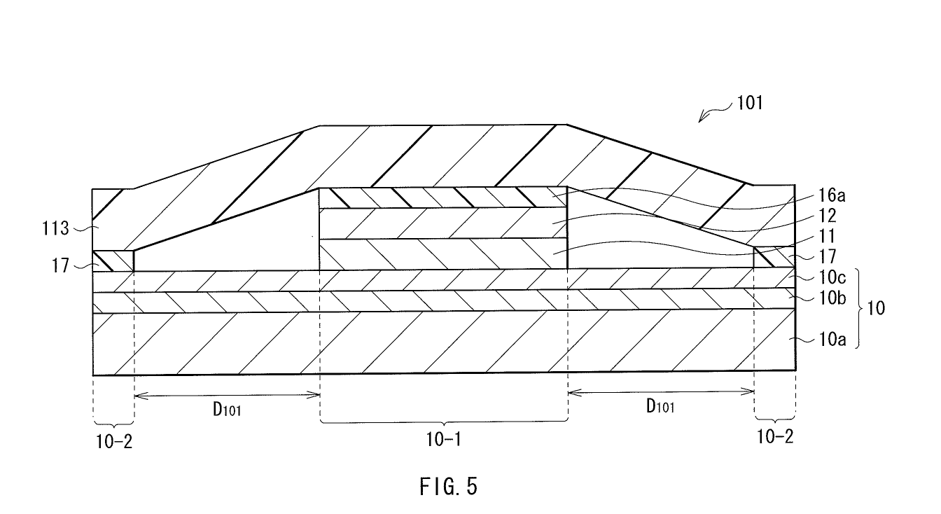

FIG. 5 illustrates a display 101 as comparative example 1. In the display 101, a protective film 113 disposed at a surface seals the display layer 11 on the drive substrate 10. The protective film 113 has a moisture proof function, an optical function such as an anti-reflection function and/or an antiglare function, and a protective function against external force, and has a thickness as large as about several hundred micrometers, for example. If the protective film 113 has such a large thickness, it is difficult to fold the protective film 113 at an acute angle along a curvature from the surface of the display layer 11 to any side face thereof in consideration of influence on the display layer 11. In other words, the protective film 113 seals the display layer 11 with a large curvature. This inevitably increases a distance D₁₀₁ between the display region 10-1 and the bonding region 10-2, leading to a large frame area.

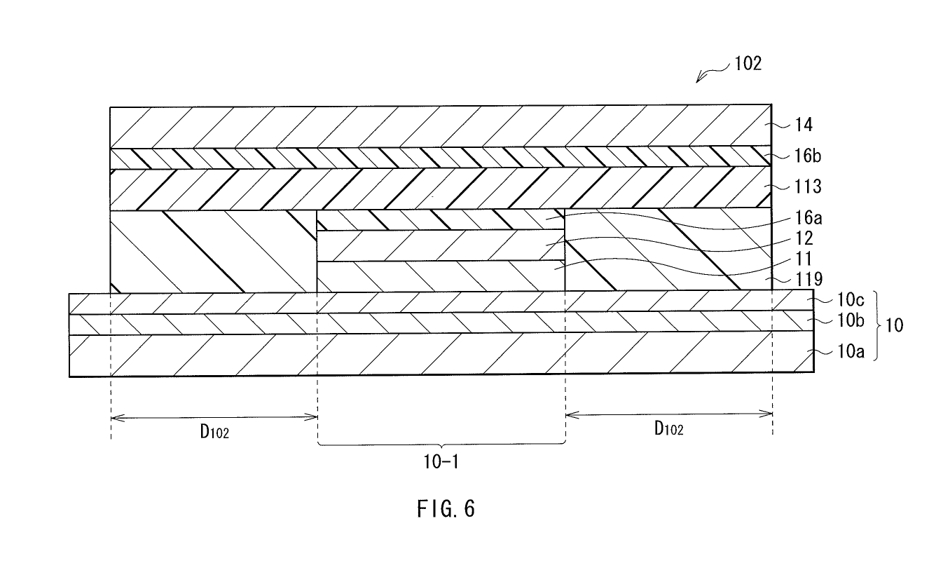

FIG. 6 illustrates a sectional configuration of a display 102 having an unfolded protective film 113 as comparative example 2. In the display 102, a water screening section 119 covers the sides of the display layer 11 and of the counter substrate 12 to improve the moisture proof property. The water screening section 119 exhibits a higher moisture proof effect with an increase in distance D₁₀₂ from its outer end to the display region 10-1. In other words, a higher moisture proof property of the display 102 disadvantageously increases the frame area thereof.

In contrast, in the display 1 of the embodiment, the moisture proof film 13 seals the display layer 11 on the drive substrate 10. As a result, an infiltration path of water from the outside into the display 1, particularly an infiltration path of water through the side faces of the display 1 is shut off, thereby leading to an improvement in the moisture proof property.

In addition, in the display 1, the moisture proof film 13 is separated from the optical functional film 14 at the uppermost surface. This allows the thickness of the moisture proof film 13 to be reduced, which further allows the moisture proof film 13 to seal the display layer 11 with a small curvature. Consequently, the distance D₁ between the display region 10-1 and the bonding region 10-2 is reduced, leading to small frame area.

As described above, the display 1 of the embodiment includes the moisture proof film 13 sealing the display layer 11 and the optical functional film 14 at the uppermost surface as two separated components having different functions. As a result, the display 1 has a high moisture proof property, and has a small distance D₁ between the display region 10-1 and the bonding region 10-2, achieving small frame size.

In addition, the display 1 has the planarization layer 15 that enables planarization of the surface of the optical functional film 14. This reduces restrictions in design of the periphery of the display section, thereby leading to an improvement in design flexibility.

Modifications of the embodiment are now described. In the following description, the same constitutional portions as those in the embodiment are designated by the same numerals and appropriately omitted from the description.

[Modification 1]

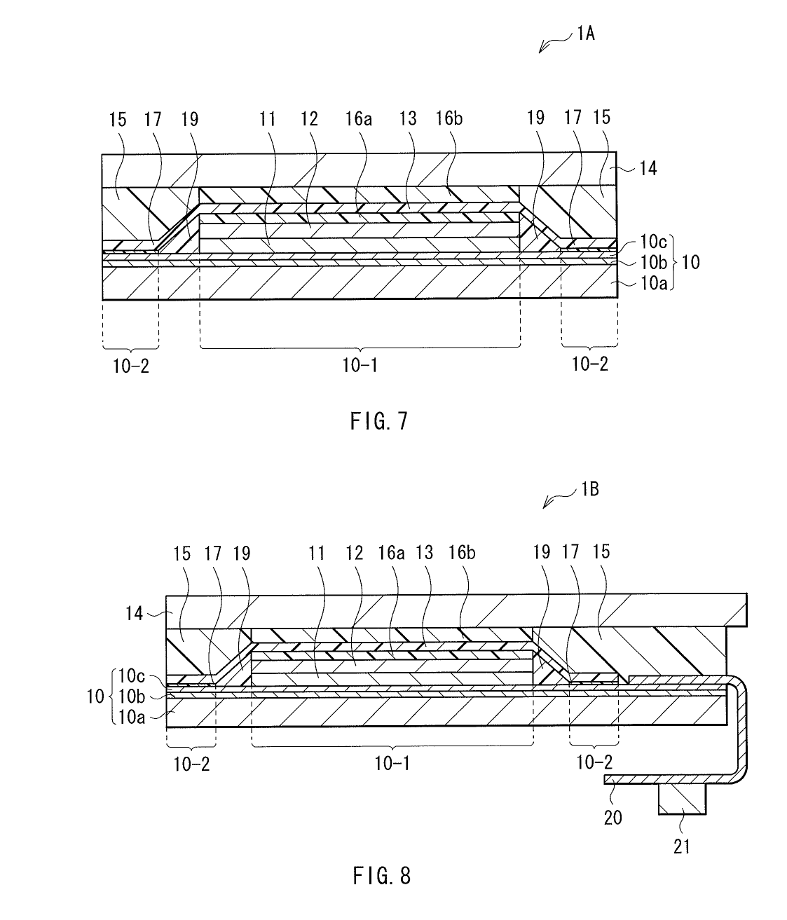

FIG. 7 illustrates a sectional configuration of a display 1A according to Modification 1. The display 1A has a water screening section 19 in place of the space 18 of the display 1. The display 1A has a configuration similar to that of the display 1 of the embodiment except for the above point, and also has functions and effects similar to those of the display 1.

The water screening section 19 is provided in contact with the side faces of the display layer 11 and of the counter substrate 12 between the display region 10-1 and the bonding region 10-2. In other words, the water screening section 19 is provided around the display layer 11 and the counter substrate 12 while being sealed on the drive substrate 10 together with the display layer 11 by the moisture proof film 13. The display 1A more effectively prevents infiltration of water through its side faces, and thus has a higher moisture proof property than that of the display 1. In addition, the display 1A does not have the space 18 (FIG. 1) between the side faces of the display layer 11 and of the counter substrate 12 and the moisture proof film 13, and thus has a high mechanical strength. The water screening section 19 is configured of, for example, a thermosetting or ultraviolet-curing acrylic, methacrylic, silicone, or epoxy resin having low moisture permeability. The moisture permeability of the water screening section 19 is preferably less than 50 g/m²/day.

[Modification 2]

FIG. 8 illustrates a sectional configuration of a display 1B according to Modification 2. The display 1B has a circuit substrate 20, on which a driver IC 21 is mounted, between the drive substrate 10 and the planarization layer 15. The display 1B has a configuration similar to that of the display 1A of the Modification 1 except for the above point, and also has functions and effects similar to those of the display 1A.

The circuit substrate 20 is folded from a surface on a side close to the display layer 11 of the drive substrate 10 to a surface on an opposite side thereof along a side face of the drive substrate 10. In this way, the circuit substrate 20 is disposed on a lower side than the optical functional film 14 (a side close to the drive substrate 10), thereby allowing the display surface of the display 1B to be entirely flat. The circuit substrate 20 is, for example, a tape automated bonding (TAB) substrate or a chip on film (COF) substrate, and has the driver IC 21 mounted thereon. The circuit substrate 20 is electrically connected to undepicted electrodes on the drive substrate 10 through, for example, an anisotropic conductive film (ACF) in order to drive the display layer 11. In the display 1B, a connection portion between the circuit substrate 20 and the electrodes is covered with the planarization layer 15, and thus it is possible to prevent infiltration of water into the connection portion without an additional coating agent such as a moisture proof coating agent. It is to be noted that although the frame area increases in correspondence to a region where the circuit substrate 20 is connected, the frame size in any other region may be reduced as in the embodiment.

The display 1B is manufactured, for example, in the following way.

First, the counter substrate 12 is formed through the certain steps as in the embodiment (FIG. 3B). Then, the moisture proof film 13 is bonded to the counter substrate 12 with the transparent adhesive agent 16a, and then the water screening section 19 is formed before bonding of the moisture proof film 13 to the drive substrate 10. For example, the water screening section 19 is formed by applying a photo-curing resin onto a region in which the water screening section 19 is to be formed, and curing the applied photo-curing resin. Here, it is preferable that, for example, oxygen plasma treatment be beforehand applied to the entire surface of the moisture proof film 13 or to at least a portion thereof to be in contact with the photo-curing resin. This improves wettability of the moisture proof film 13, and facilitates application of the photo-curing resin.

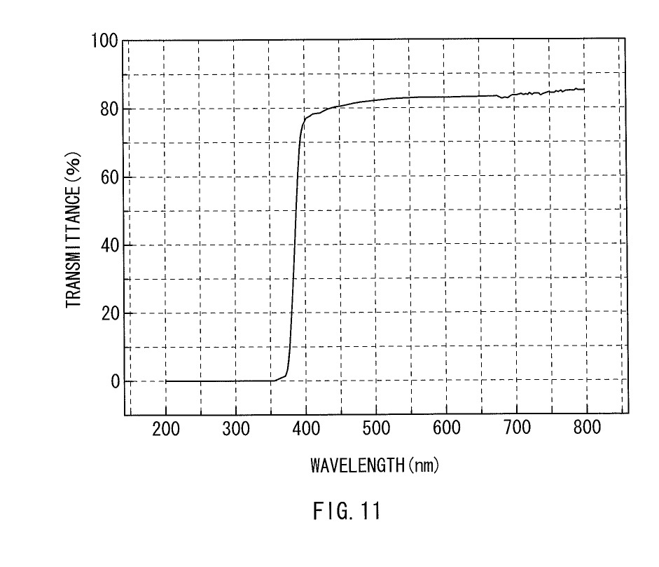

In addition, for example, if the moisture proof film 13 has an ultraviolet screening function, the water screening section 19 is preferably formed of a resin material that is curable by light having a wavelength out of the wavelength range of the ultraviolet rays to be screened. FIG. 11 illustrates an exemplary relationship between wavelengths and light transmittance of the moisture proof film 13 having the ultraviolet screening function. In the case where such a moisture proof film 13 is used, a resin material, which is curable by being irradiated with light (visible light) having a wavelength longer than 380 nm, is preferably used.

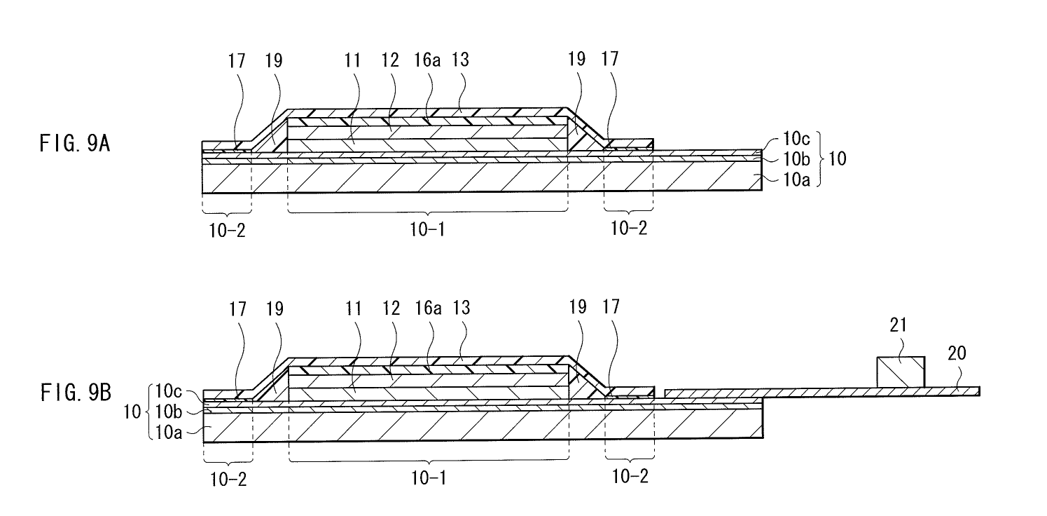

After formation of the water screening section 19, as illustrated in FIG. 9A, the moisture proof film 13 is fixed to the drive substrate 10 with the adhesive agent 17. The adhesive agent 17 may be composed of the same resin material as that for the water screening section 19. After fixing of the moisture proof film 13 to the drive substrate 10, as illustrated in FIG. 9B, the circuit substrate 20 on which the driver IC 21 is mounted is connected to the undepicted electrodes on the drive substrate 10 by ACF, for example.

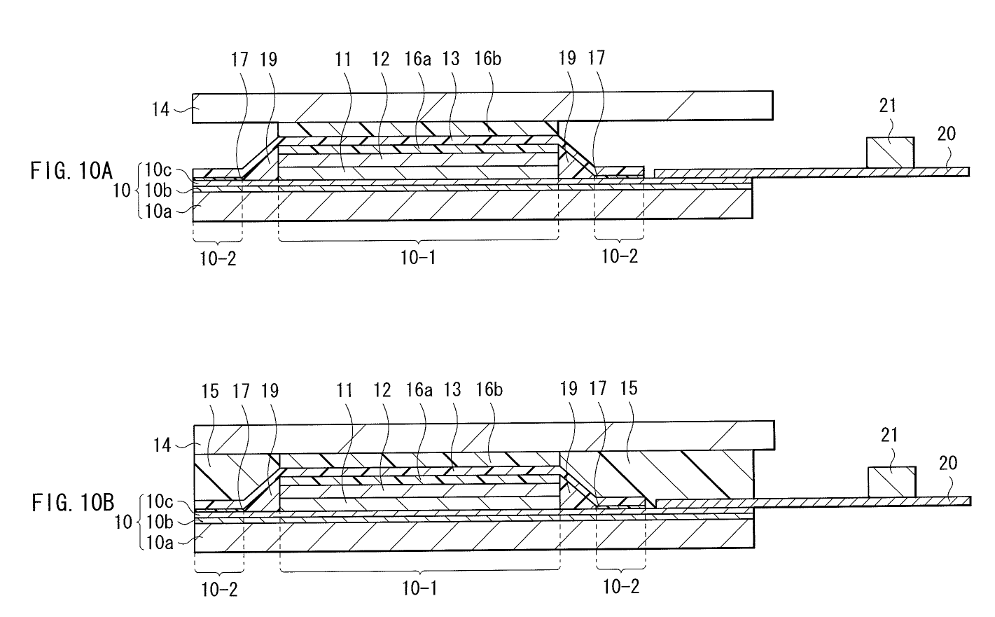

After connection of the circuit substrate 20, as illustrated in FIG. 10A, the optical functional film 14 is fixed onto the moisture proof film 13 with the transparent adhesive agent 16b. Then, the planarization layer 15 is formed as illustrated in FIG. 10B. After formation of the planarization layer 15, the circuit substrate 20 is folded, and thus the display 1B is completed.

[Modification 3]

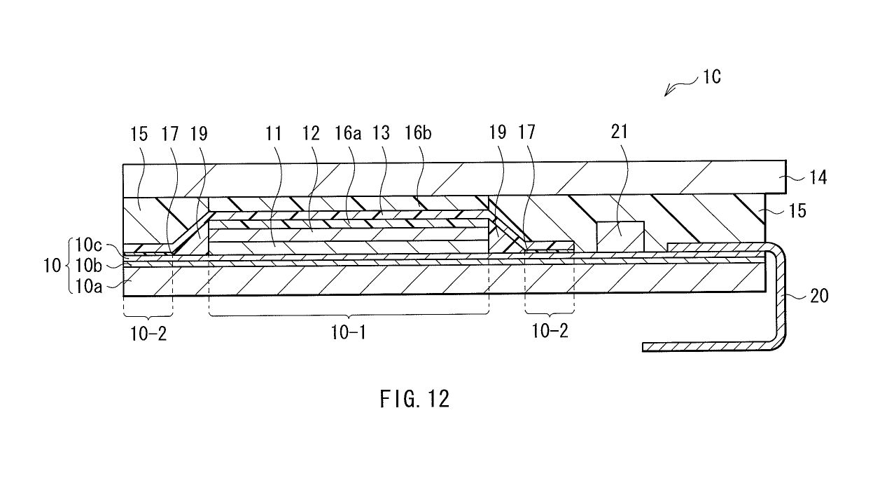

FIG. 12 illustrates a sectional configuration of a display 1C according to Modification 3. The display 1C includes a drive substrate 10 on which the driver IC 21 is directly mounted. The display 1C has a configuration similar to that of the display 1B of the Modification 2 except for the above point, and also has functions and effects similar to those of the display 1B.

The driver IC 21 is mounted on the drive substrate 10 by chip on glass (COG), COF, or other techniques. A circuit substrate 20 is connected, separately from the driver IC 21, to the drive substrate 10 in order to input control signals.

The display 1C is manufactured, for example, in the following way.

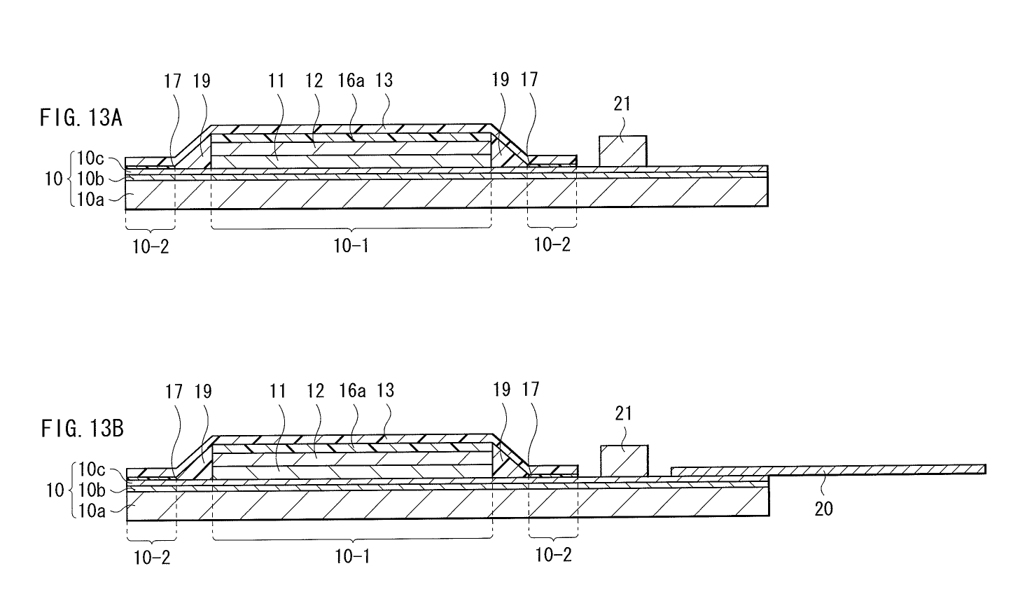

First, the moisture proof film 13 is bonded to the drive substrate 10 as in the Modification 2 (FIG. 9A). Then, as illustrated in FIG. 13A, the driver IC 21 is mounted onto the drive substrate 10 by COF, for example. Then, as illustrated in FIG. 13B, the circuit substrate 20 is connected to undepicted electrodes on the drive substrate 10 by ACF, for example.

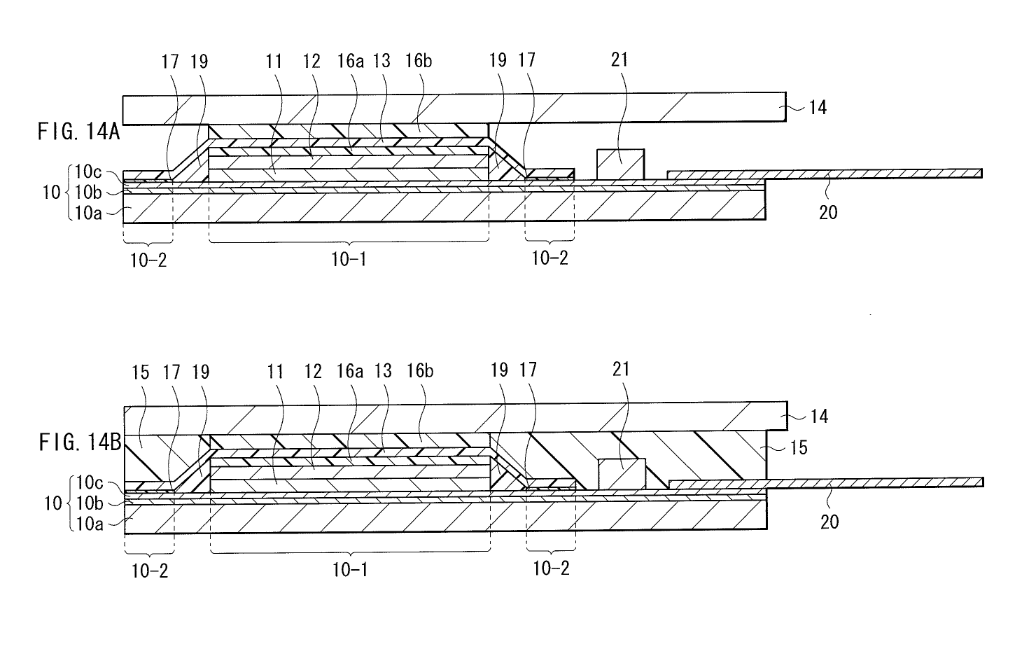

After connection of the circuit substrate 20, as illustrated in FIG. 14A, the optical functional film 14 is fixed onto the moisture proof film 13 with the transparent adhesive agent 16b. Then, the planarization layer 15 is formed as illustrated in FIG. 14B. After formation of the planarization layer 15, the circuit substrate 20 is folded, and thus the display 1C is completed.

The displays 1, 1A, 1B, and 1C each allow a reduction in frame area, and allow their uppermost surfaces to be maintained to be flat. This enables each of the displays to be applied to an electronic unit called Electronic Book displaying electronic books, or to an electronic unit incorporating a touch panel therein, for example. In addition, the displays 1, 1A, 1B, and 1C are each allowed to be mounted in electronic units shown in application examples 1 to 6 below. Here, the display may be mounted with a support substrate configured of, for example, polyethylene terephthalate (PET) provided on the bottom (a side opposite to a side close to the display layer 11) of the drive substrate 10.

### APPLICATION EXAMPLE 1

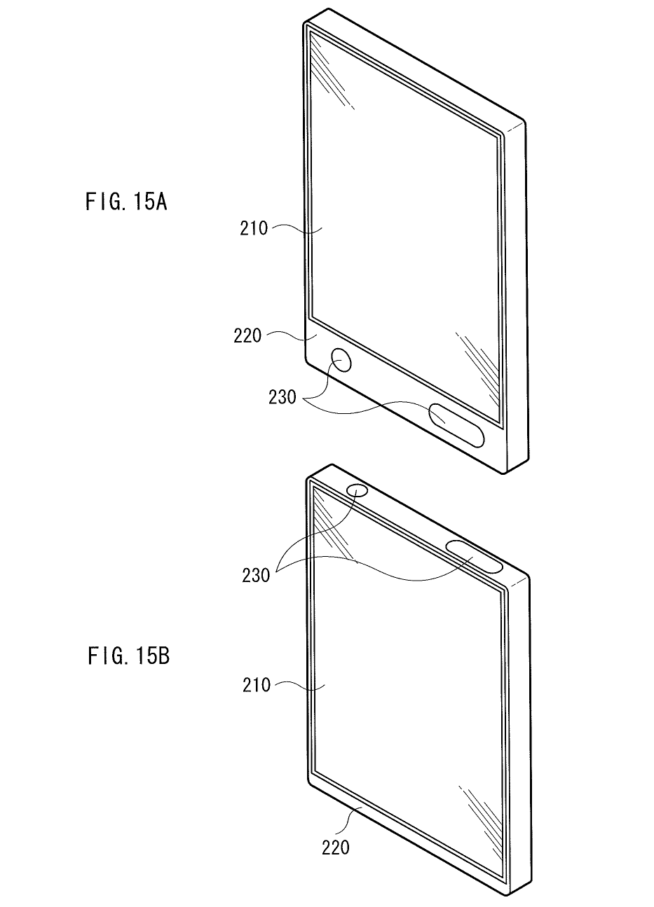

FIGS. 15A and 15B illustrate an appearance of an electronic book. The electronic book includes a display section 210, a non-display section 220, and an operational section 230, for example. The operational section 230 may be provided on the same face (front face) as a face of the display section 210 as illustrated in FIG. 15A, or may be provided on a face (top) different from the face thereof as illustrated in FIG. 15B.

### APPLICATION EXAMPLE 2

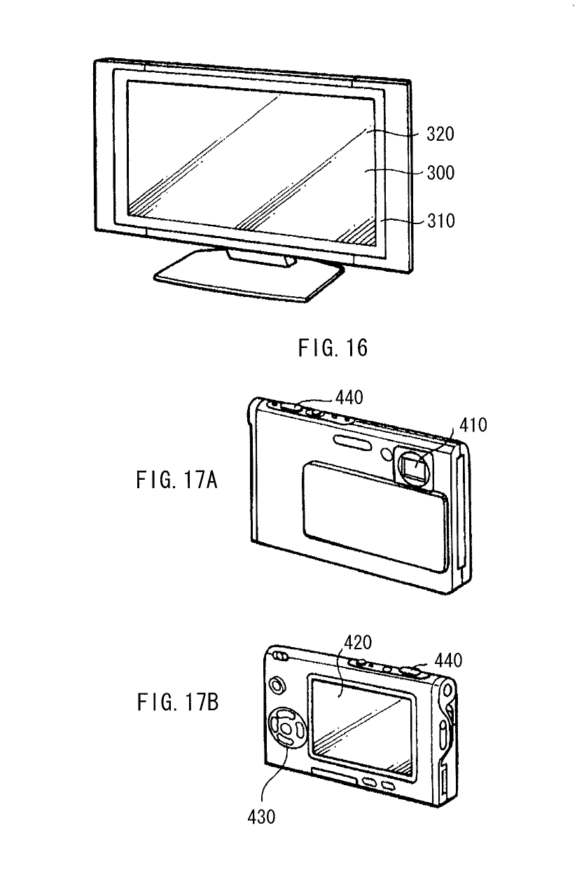

FIG. 16 illustrates an appearance of a television apparatus. The television apparatus includes, for example, an image display screen section 300 including a front panel 310 and a filter glass 320.

### APPLICATION EXAMPLE 3

FIGS. 17A and 17B illustrate an appearance of a digital still camera. The digital still camera includes, for example, a light emitting section 410 for flash, a display section 420, a menu switch 430, and a shutter button 440.

### APPLICATION EXAMPLE 4

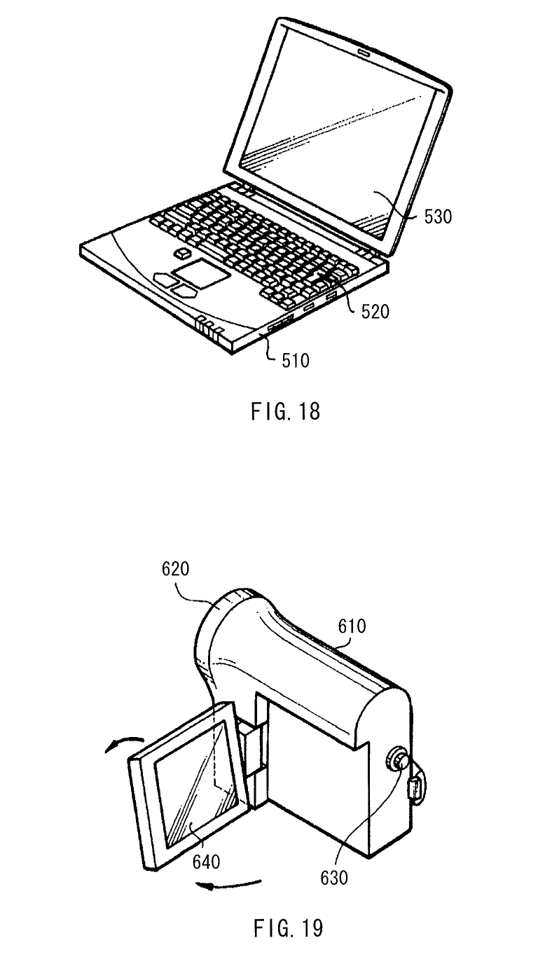

FIG. 18 illustrates an appearance of a notebook personal computer. The notebook personal computer includes, for example, a main body 510, a keyboard 520 for input operation of characters and the like, and a display section 530 that displays images.

### APPLICATION EXAMPLE 5

FIG. 19 illustrates an appearance of a video camcorder. The video camcorder includes, for example, a main body section 610, an object-shooting lens 620 provided on a front side face of the main body section 610, a start-and-stop switch 630 for shooting, and a display section 640.

### APPLICATION EXAMPLE 6

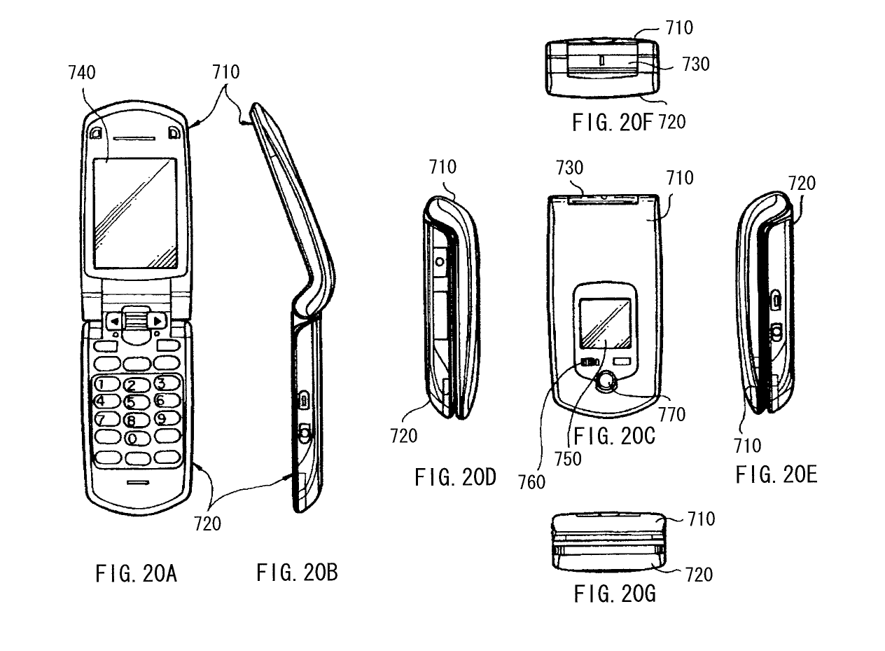

FIGS. 20A to 20G illustrate an appearance of a mobile phone. For example, the mobile phone is configured of an upper housing 710 and a lower housing 720 connected to each other by a hinge section 730, and includes a display 740, a sub display 750, a picture light 760, and a camera 770.

Although the present application has been described with the embodiment and the Modifications hereinbefore, the present application is not limited thereto, and various modifications or alterations of the application may be made. For example, although the embodiment and the Modifications have been described with a case where the moisture proof layer covers the side faces of the display layer, if the drive substrate is configured of a flexible material, the drive substrate may cover the side faces of the display layer.

In addition, for example, the material and the thickness of each layer or the film formation process and the film formation condition thereof have been unlimitedly described in the embodiment and the Modifications. Other materials and/or thickness, or other film formation processes and/or film formation conditions may be used.

Furthermore, although the embodiment and the Modifications have been described with the specific configuration of each of the displays 1, 1A, 1B, and 1C, the described layers may not be fully provided, or another layer may be added.

Note that the present application may be configured as follows.

(1) A display including:

a drive substrate having a display region and a bonding region around the display region;

a display layer provided on the display region;

a surface film disposed to face a display surface of the display layer; and

a moisture proof film interposed between the display layer and the surface film while being in contact with the drive substrate in the bonding region, and sealing the display layer between the moisture proof film and the drive substrate.

(2) The display according to (1), wherein the moisture proof film covers a top and side faces of the display layer, and the drive substrate covers a bottom of the display layer.

(3) The display according to (2), further including:

a planarization layer between the moisture proof film and the surface film in a region outside the display region.

(4) The display according to (3), wherein the planarization layer is configured of resin.

(5) The display according to any one of (1) to (4), further including:

a water screening section in contact with side faces of the display layer, between the display region and the bonding region.

(6) The display according to any one of (1) to (5), wherein the surface film has one or more of an anti-reflection function, an antiglare function, an ultraviolet screening function, and a protective function against external force.

(7) The display according to any one of (1) to (6), wherein a circuit substrate for drive of the display layer is provided on the drive substrate.

(8) An electronic unit including a display, the display including:

a drive substrate having a display region and a bonding region around the display region;

a display layer provided on the display region;

a surface film disposed to face a display surface of the display layer; and

a moisture proof film interposed between the display layer and the surface film while being in contact with the drive substrate in the bonding region, and sealing the display layer between the moisture proof film and the drive substrate.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A display, comprising:
a drive substrate having a display region and a bonding region around the display region;
a display layer provided on the display region;
a surface film disposed to face a display surface of the display layer; and
a moisture proof film interposed between the display layer and the surface film while being in contact with the drive substrate in the bonding region, and sealing the display layer between the moisture proof film and the drive substrate.

2. The display according to claim 1, wherein the moisture proof film covers a top and side faces of the display layer, and the drive substrate covers a bottom of the display layer.

3. The display according to claim 2, further comprising:
a planarization layer between the moisture proof film and the surface film in a region outside the display region.

4. The display according to claim 3, wherein the planarization layer is configured of resin.

5. The display according to claim 1, further comprising:
a water screening section in contact with side faces of the display layer, between the display region and the bonding region.

6. The display according to claim 1, wherein the surface film has one or more of an anti-reflection function, an antiglare function, an ultraviolet screening function, and a protective function against external force.

7. The display according to claim 1, wherein a circuit substrate for drive of the display layer is provided on the drive substrate.

8. An electronic unit including a display, the display comprising:
a drive substrate having a display region and a bonding region around the display region;
a display layer provided on the display region;
a surface film disposed to face a display surface of the display layer; and
a moisture proof film interposed between the display layer and the surface film while being in contact with the drive substrate in the bonding region, and sealing the display layer between the moisture proof film and the drive substrate.
